(19) United States
(12) Patent Application Publication
(10) Pub. No.: US 2016/0178772 A1
(43) Pub. Date: Jun. 23, 2016

(54) High Resolution Estimation of Attenuation from Vertical Seismic Profiles

(71) Applicant: STATOIL PETROLEUM AS, Stavanger (NO)

(72) Inventor: Andrew James Carter, Trondheim (NO)

(21) Appl. No.: 14/892,667

(22) PCT Filed: May 27, 2014
(86) PCT No.: PCT/EP2014/060988

§ 371 Date: Nov. 20, 2015

(30) Foreign Application Priority Data
May 27, 2013 (EP) PCT/EP2013/060848

(51) Int. Cl. G01V 1/28; G01V 1/36

(52) U.S. Cl. CPC G01V 1/282; G01V 1/36; G01V 2210/56; G01V 2210/584

(57) ABSTRACT

A method of obtaining an attenuation model estimate for a vertical seismic profile (VSP). The method may include the steps of receiving a vertical seismic profile dataset, the VSP dataset having been generated by recording a wavefield at a number of depth levels, building an estimate of a number of changes in an attribute of the wavefield sensitive to attenuation between respective pairs of depth levels based on the VSP dataset, producing a number of corrected changes in the attribute between the respective pairs of depth levels by modeling local interference of the wavefield from interfaces near each of the depth levels using information including measured well log and/or borehole information and correcting the estimated changes in the attribute for this interference, choosing and fitting an attenuation law to the corrected transfer functions, and outputting an attenuation model.

### TECHNICAL FIELD

The present invention relates in general to exploration geophysics, borehole geophysics, borehole seismology, rock physics and in particular the interpretation and processing of seismic/sonic log, density log and shear wave sonic well log data to estimate the local reflectivity around a receiver, and to compensate for the interference these effects cause to the attenuation estimates in development and production settings.

### BACKGROUND ART

Seismic measurement systems comprising a transmitter and receiver measure the time it takes for a sound “pulse”, or elastic wave, to travel from the transmitter to the receiver or receivers. Sonic log, density log and shear wave sonic well log data assist in providing information to support and calibrate seismic data and to provide information that can also be used to derive the velocity of elastic waves through the formation. Commonly geophones or hydrophones, arranged in an array or line formation, are used. In the present text the general term receiver or receivers is used. Receiver arrays may be placed on the seabed, towed behind a ship or placed on land. A line of receivers may be placed on the seabed, towed behind a ship on land or in a well. Depending on the system configuration, the source or receivers may be mobile. As is generally known in the field, the transmitted pulse from a seismic source is very short and of high amplitude and travels through the rock in various different forms while undergoing dispersion of the wave energy in time and space and attenuation. When the sound energy arrives at the receiver, having passed through the rock, it does so at different times in the form of different types of waves. The different types of waves travel with different velocities in the rock or take different pathways to the receiver. After a period the first type of wave, the compressional or longitudinal or pressure wave (P-wave), arrives. The P-wave is usually the fastest wave, and has a small amplitude. The next wave to arrive is the transverse or shear wave (S-wave). The S-wave is slower than the P-wave, but usually has a higher amplitude. The S-wave cannot propagate in fluids, as fluids do not behave elastically under shear deformation. A so-called dimensionless quality factor, or Q-factor, Q-value or simply Q can be defined as the ratio of the energy of a seismic wave to the energy dissipated per wave cycle. Q is a measure of signal attenuation through a formation and the intrinsic property of the material, and thus is a very important required factor in extracting useful subsurface material properties such as litho logical information, porosity, overpressure, permeability, fluid viscosity, and the degree of fluid saturation from the seismic data. Q is typically about 30 for weathered sedimentary rocks and about 1000 for granite.

There exist a large number of methods for Q estimation from vertical seismic profile (VSP) data. Most of these involve the comparison either of the spectral content, amplitudes, of direct arrival waveforms extracted from the downgoing wavefield. A range of such methods is reviewed by Tonn (1991) and Jannsen et al. (1985). In addition to ten or so methods reviewed in the above articles there are methods based on: instantaneous trace attributes (Engelhard, 1996; Haase and Stewart, 2005); a method based on the energy flux theorem (Dillon, 1991); multi-channel beamforming methods (Harris et al., 1997); homomorphic deconvolution (Goloshubin and Bayuk, 2010); Gabor domain methods (Ferguson et al., 2009); iterative modeling methods (Dietrich and Bouchon, 1985); as part of a simultaneous inversion with that for P-wave phase velocity (Amundsen and Mittet, 1994); P-wave dispersion (Stewart et al., 1984); and viscoelastic full waveform inversion type methods (Barnes, 2010; Yang et al., 2009). There are likely many other methods and published examples and variations on most of the methods mentioned above. These include methods based on coherency-maximisation. The scientific literature on Q estimation from VSP is considerable.

Note that all of the above methods involve the choice of some kind of mathematical model, also referred to here as an attenuation law, for the effects of seismic absorption (e.g. Kjartansson, 1979; Futterman, 1962), and some kind or assumption, or method for either inclusion or exclusion in the results of the loss of high frequencies due to purely elastic scattering (O'Doherty and Anstey, 1971). There remains uncertainty about the most appropriate choice of mathematical model for seismic absorption, since when suitably parameterized, it may be possible to fit several models to data observations (Toverud and Ursin, 2005), and there is experimental evidence that Q varies as a function of frequency (Sams et al., 1997), and also some evidence that it can even vary within the narrow band of a seismic experiment (Kan et al., 1983; Jacobsen, 1987). Separation of elastic scattering losses from absorption losses is also problematic, although this can be done at wells in a model-based way (Schoenberger and Levin, 1974; 1978). The relative magnitude of high frequency losses due to absorption and due to elastic scattering appears to be geology dependent, there even exist cases where all of the attenuation could potentially be explained by elastic scattering (Worthington and Hudson, 2000).

The term “scattering attenuation” refers to the effect of loss of high frequencies on field data due to elastic scattering and includes, for example, Rayleigh scattering and Mie scattering.

For modeling purposes, the loss of high frequencies due to elastic scattering can also be referred to as “stratigraphic attenuation”, when the quantity assumes a model whose macroscopic properties vary only with depth.

The term “intrinsic attenuation” is defined as the loss of high frequencies due to seismic absorption, which could be caused by one or several of many mechanisms including, but not limited to, squirt flow, global fluid flow, viscoelasticity, grain boundary friction. The term “effective attenuation” is defined either as the combined effect of scattering attenuation and intrinsic attenuation on field data, or as the combined effect of stratigraphic attenuation and intrinsic attenuation when referring to models or simulated data where macroscopic earth properties vary only with depth.

The following paragraphs describe the most common assumptions and approach, which is typically based on either a constant-Q (CQ) (Kjartansson, 1979) or nearly-constant Q (NCQ) (e.g. Futterman, 1962) model combined with a method known as the spectral ratio method.

Pujol and Smithson (1991) and Newman and Worthington (1982) both give useful reviews of the spectral ratio method. In its simplest form the spectral ratio method involves comparing the amplitude (or power) spectra of the downgoing direct wave estimated at two or more receivers. Effects of:
elastic scattering;
interference due to reflections and local conversions;
source and receiver coupling;
source repeatability;
non-zero incidence angle (and potentially accompanying anisotropy effects);
window bias (Pujol and Smithson, 1991);
and frequency-dependent geometric spreading (as is theoretically the case for a viscoelastic medium);
   are all either ignored/assumed small, built into the Q estimates, or compensated for by methods which vary from implementation to implementation.

After ignoring or correcting for the above effects, one typically assumes that the amplitude spectrum of a wave travelling vertically (or near vertically) obeys the relationships below (Aki and Richards, 1980; Wang, 2008):

$$A ( ω ) = {k}_{1} {A}_{0} ( ω ) exp [ - α ( ω ) ( z - {z}_{0} ) ] = {k}_{1} {A}_{0} ( ω ) exp [ \frac{- ω ( t - {t}_{0} )}{2 Q} ] \qquad ( 1 )$$

Where: A(w) is the amplitude spectrum of the direct downgoing wave at depth z after travelling through a homogeneous medium with absorption coefficient α(ω) from the shallower depth z₀ at which depth (typically known as the “reference depth”) it had the amplitude spectrum A₀(ω), and k₁ is a constant that takes into account frequency-independent amplitude changes during propagation.

Note that equation (1) has made use of the approximation:

$$Q ≅ \frac{ω}{2 c α ( ω )} ,$$

which is valid for low absorption, e.g. Q≧20.

In the spectral ratio method one can formulate the ratio:

$$ln ( \frac{A ( ω )}{{A}_{0} ( ω )} ) = {k}_{2} - \frac{ω ( t - {t}_{0} )}{2 Q} \qquad ( 2 )$$

where: t and tₒ are the arrival times of the direct downgoing arrivals at depths z and z₀ respectively, k₂ is a constant resulting from frequency-independent effects on amplitude, and Q is the quality factor of the homogeneous medium (or the effective medium if it is not homogeneous) between these two depths.

Over the frequency bandwidth within which the signal of both waveforms dominates the noise, a regression line is fitted to the log spectral ratio as a function of frequency. Outside of this bandwidth, equations (1) and (2) do not apply.

Therefore, (2) one can use estimates for t, tₒ and the amplitude spectral ratio from the VSP data to estimate 1/Qz₀→z using:

$$\frac{1}{{Qz}_{0} \to z} = - \frac{2 m}{t - {t}_{0}} \qquad ( 3 )$$

It is worth noting that 1/Q is estimated not Q, and so statistics and uncertainties should be obtained on 1/Q not Q. In practice there are various details such as smoothing of travel time picks, how the downgoing wavefield is separated, dealing with coupling issues and source repeatability, as well as how the waveform is windowed and the Fourier amplitude spectrum estimated. In practice a number of depth ranges are considered, and many methods use all possible pairs of receiver depths that satisfy some criterion such as minimum depth separation. Such a criterion is necessary in practice since there is a noise level on the measurements, and when the receivers are very close together in depth noise may dominate over the very small gradient caused by absorption (Spencer et al., 1977; 1982, Mateeva, 2003). These estimates from different, overlapping, depth pairs can then be combined within inversions with various constraints.

Note that if one chooses to use other attenuation models than CQ or NCQ models then the spectral ratio method cannot be used without modification. However, any attenuation model can, in principle be handled in VSP Q estimation. Instead of forming the spectral ratio between two recorded waveforms one instead estimates the transfer functions between pairs of waveforms, perhaps using match filters (Raikes and White, 1984), and then invert the transfer functions for Q values according to the attenuation model chosen.

All of the methods currently used by contractors suffer from the limitation, highlighted and explained in detail in Carter (2003) for the closely related problem of Q estimation from surface seismic, that they do not attempt to separate the propagating seismic wavelet out from the received signal. Even in a horizontally stratified medium most seismic reflection events are typically an interference pattern made from several overlapping primary reflection events, also potentially overprinted by multiply reflected energy generated from the layers above. This causes problems in Q estimation from both VSP and surface seismic reflection data.

For example, in zero offset VSP data the first arrival recorded is a downgoing P-wave. In a subsurface made from a homogeneous half-space this first arrival would be a perfect copy of the downward propagating wavelet from the source to receiver. However, in reality this downgoing P-wave is typically overprinted both by forward scattered multiples generated in the overburden, and reflections generated just above and below the receiver depth. The criterion for such a noise event to interfere with the primary is that the event lags behind the primary with a lag or delay small enough that it contributes to the time window used to isolate the downgoing wave. The first order interference effect here comes from geological layers and contrasts just below the receiver. These will typically be largest since they have reflected only once and the reflection coefficients in the subsurface are typically rather small.

The most problematic are the interfering reflections which have a very short delay compared to the primary as these interfere constructively and will broaden the pulse of the downgoing arrival. Such reflections are very difficult to filter out.

It is possible to reduce the effect of interfering reflections by attempting to separate the upgoing and downing wave fields using either median filtering on data aligned on the first break, or using other wavefield separation methods such as F-K filters or SVD, PCA, ICA, or K-L transform based approaches. In the case where the lag of the reflected energy is small, all of these methods may fail to recover the true shape of the downgoing propagating wavelet. Another way to reduce the influence of such interfering reflections is to only form Q estimates using receiver pairs that are separated by at least a certain depth separation (typically a few hundred metres), e.g. Spencer et al. (1982), Mateeva (2003). The idea here is that the attenuation effect to be measured becomes larger relative to the noise in the measurement from the interference. Other experimenters have tried to avoid the problem by averaging estimates (e.g. Wang, 2008), or discriminating against negative Q values and discarding them (e.g. Blias, 2012) where all receiver pairs are used that provide reasonable (or, expected within predefined error limits) Q values. Sometimes measurement parameters such as the choice of bandwidth over which to perform a linear regression of a spectral ratio, are chosen to prevent negative or unrealistic Q values. There are some exceptions to these limitations in the prior art, such as:

1. White (1992), Raikes and White (1984), and Ning and Lu (2010) which include examples of estimation of Q using wavelet estimates as opposed to individual arrivals, however these approaches are all used on surface seismic data not VSP;
2. Hackert and Parra (2004) and Parra et al. (2006) who attempt to correct Q estimates from surface seismic for the influence of the local reflectivity using well logs.
3. Amundsen and Mittet (1994) attempted to correct for the impact of reflections from major interfaces on their Q estimates using a model-based approach, but neglect the influence of minor interfaces close to the receivers.
4. The examples of viscoelastic and viscoacoustic full waveform inversion and attenuation tomography (e.g. Yang et al., 2009) could in principle correct for the effects of local reflectivity on the spectrum, but this would require an extremely finely discretised model and the inclusion of many orders of multiples in the forward model within the inversion. This kind of inversion would require a starting model that would be very difficult to estimate, and would also likely be very expensive to update.

The contractor knows the range of intrinsic Q values that are likely (based on “experience” and laboratory experiments made on small samples, often at much higher frequencies) for a particular lithology from the literature, and the contractor performing the Q estimation typically has access to well log data, such that they have an idea of the variation of lithology with depth. There is often therefore a temptation to ensure that the Q estimates obtained agree with those expected for a typical lithology. In other words the Q estimate may not always be obtained in an objective manner, in that it is open to user bias given the measurement parameters that can be adjusted to provide values that will satisfy the client.

For this reason many Q values estimated from VSP are not trustworthy. Such Q values are not useful for use in inverse-Q filtering within seismic processing or imaging, nor are they useful for the calibration of Q as a seismic attribute, or the testing of the extension of laboratory based theories by field-scale observations. They add “noise” to any interpretational or processing experiments that geophysicists attempt to perform that involve Q. In addition, the Q values estimated are a combination of the scattering attenuation due to peg-leg multiples within fine layering above the receiver (O'Doherty and Anstey, 1971), and any other elastic scattering losses, as well as the intrinsic absorption itself. This can be appropriate if the application of the Q values is a correction of a seismic response for overburden effects, provided that the chosen absorption model gives a reasonable fit to the frequency-dependence of the scattering induced preferential losses of high frequency observed within the bandwidth of the VSP experiment, and that it satisfies the common assumption that the stratigraphic attenuation and the intrinsic attenuation are approximately additive in terms of their 1/Q values (Lerche and Menke, 1986). Whether or not it is appropriate to build stratigraphic attenuation into such a Q value will in general be geology-dependent.

Uncertainty estimates are often based on error bars resulting from a linear regression to the log (spectral ratios). These can be very over optimistic, as such error bars assume that, that a linear model is appropriate for the log (spectral ratio) over the bandwidth analysed, and that the errors are random and Gaussian, whereas in fact the deviations from linearity in a spectral ratio can be strongly correlated as a function of frequency, especially where they are due to interference from the local reflectivity around the receiver. It is important that these error estimates are not reduced still further by including non-independent data points (that result from zero padding in FFTs, for example) in the uncertainty calculation from the regression. The reduction of the number of degrees of freedom in the spectral estimates due to spectral smoothing should also be taken into account in estimating the uncertainties (White, 1992).

Such limitations of VSP spectral ratios have been known for a long time (Spencer et al., 1982; Kerner and Harris, 1994), but are typically ignored, as “reasonable looking” Q estimates can often be obtained by adjustment of the measurement parameters such as receiver depths and regression bandwidth. Also spectral ratios estimated from short time segments of data will often appear linear in form over some subset of the signal bandwidth. Thus, this problem is hidden, but it hinders any significant progress on the compensation of seismic images for absorption, learning more about absorption and the geological controls on it, and the possibility of the use of absorption as an attribute in exploration and production. The spectral interference due to the local reflectivity around the receiver is expected to be more problematic in finely-layered media consisting of materials with strongly contrasting and/or cyclic impedances (e.g. seismic imaging below basalt, which is currently an important commercial topic).

Published documentation describing the existing technology is listed at the end of the detailed description section.

### SUMMARY OF THE INVENTION

For the estimation of intrinsic and effective attenuation from vertical seismic profiles the present method utilizes measurement data based on sonic, density and, if necessary, shear wave sonic well logs to estimate the local reflectivity around the receiver and compensate for the interference these effects cause to the attenuation estimates.

The above mentioned deficiencies and uncertainties associated with the prior art are rectified by way of the following novel improvements.

In a first aspect the present invention provides a method of obtaining an attenuation model estimate for a vertical seismic profile (VSP), comprising: receiving a vertical seismic profile dataset, the VSP dataset having been generated by recording a wavefield at a plurality of depth levels; building an estimate of a plurality of changes in an attribute of the wavefield sensitive to attenuation between respective pairs of depth levels based on the VSP dataset; producing a plurality of corrected changes in the attribute between the respective pairs of depth levels by modeling local interference of the wavefield from interfaces near each of the depth levels using information comprising measured well log and/or borehole information and correcting the estimated changes in the attribute for this interference; choosing and fitting an attenuation law to the corrected transfer functions; outputting an attenuation model.

The VSP dataset may comprise data concerning wavefield propagation from a source to the plurality of depth levels. The data may be measured at the plurality of depth levels by a receiver placed at the/each depth levels.

At each of these levels, the wavefield may be measured. The attenuation model may be built using data of selected arrivals of the wavefield at the depth levels, e.g. the first arrival. In order to capture only the selected arrivals, the measurements at each level may be taken at particular times, and over particular time periods (i.e. time windowed measurements). However, even with this time windowing, the measured data may also include interference, which may be due to reflections and/or scattering. The interference may add one or more additional arrival to the wavefield, which may arrive at the depth levels within the windowed time. This may affect the measurement of the selected arrival.

The interference may be caused by reflections at the interfaces between differing rock-types or geological layers. The interfaces for which local interference is modeled may be the interfaces within a certain distance, or wavefield travel time, of the depth level in question. This distance/travel time may be the distance/travel time that is sufficiently small so that the reflection from the interfaces within the distance/travel time arrives within the selected time window. Reflections from interfaces which arrive outside the time window may need not be accounted for since they do not affect the measurement of VSP data.

In order to increase the number of datapoints measured in the VSP dataset, it is desirable to have a long time window. However, this previously would have lead to a large amount of interference. By correcting for interference from the relevant interfaces near the depth levels using measured well log and/or borehole information, longer time windows can be used without the undesirable increase in interference.

The change in the attribute of the wavefield sensitive to attenuation may be a transfer function. Thus, an estimate of a plurality of transfer functions of the wavefield between respective pairs of depth levels may be built based on the VSP dataset. The change in the attribute of the wavefield sensitive to attenuation may be a change in instantaneous frequency, a change in rise time, a change in peak amplitude, a spectral ratio, a change in centroid frequency, a time-domain attribute, a frequency-domain attribute, a time-frequency-domain attribute, and/or any other suitable attribute.

The model of the earth, or region around the bore hole, which may be used when modeling the correction, may be a horizontally-layered or stratified medium.

The method may also comprise separating upgoing and downgoing wavefields of the wavefield, and correcting the estimated changes in the attribute of the wavefield for the downgoing wavefield. The attenuation may be improved due to both the wavefield separation and the reflectivity correction. These need not be mutually exclusive. In cases where the reflectivity correction does not improve the Q estimates as much as the wavefield separation there may still be a benefit from applying a version of the reflectivity correction that has had the same wavefield separation filter applied to it as the data, to the Q estimates. This can be important as, in practice, it may be the best way to perform the method for datasets containing very strong reflections.

Modeling local interference of the wavefield from interfaces near each of the depth levels may comprise removing reflections of the wavefield from the interfaces within a user-specified distance or travel time of each depth level, but not removing scattering losses of the wavefield.

Scattering losses may be considered to be losses in the wavefield which arise from its propagation through the rock. Scattering losses may be transmission losses, i.e. losses which occur as the wavefield is transmitted through the rock. Scattering losses may occur due to backscattering reflections, and/or any other scattering mechanism. The scattering losses may occur as the wavefield propagates between each pair of depth levels. The scattering losses may occur due to elastic scattering.

Scattering may cause progressive preferential loss of high frequencies of the wavefield as it propagates. The main elastic scattering mechanism that may be responsible for the progressive preferential loss of high frequency may be the forward scattering of multiple reflections from sequences of many thin layers bounded by interfaces with reflection coefficients of alternating sign. These layers may forward-scatter copies of the primary propagating wavelet with a slight time delay that is a fraction of the dominant period of the primary. These copies may interfere constructively with the primary, broadening the pulse and thereby reducing its bandwidth. Such multiples are sometimes referred to in exploration geophysics as “friendly multiples”, as although they broaden the pulse of the wavelet, they increase its amplitude, allowing seismic to image through finely layered media. The transmission coefficients of the interfaces may be approximated as frequency-independent and so may not be of particular relevance as long as the attribute of the wavefield sensitive to attenuation that is chosen is not also sensitive to the peak amplitude, but actually uses the frequency dependence of amplitude and/or phase.

The attenuation law may be an effective attenuation law and the attenuation model may be an effective attenuation model.

The method may further comprise: producing the plurality of corrected changes in the attribute by also modeling scattering effects of the wavefield between the respective pairs of depth levels using the information comprising well log and/or borehole information, and correcting the estimated changes in the attribute for these scattering effects.

The scattering effects may be transmission effects.

Modeling local interference of the wavefield from interfaces near each of the depth levels may comprise removing reflections from the interfaces within a user-specified distance or travel time of each depth level, and modeling scattering effects of the wavefield between the respective pairs of depth levels comprises removing scattering losses of the wavefield between the respective pairs of depth levels.

The attenuation law may be an intrinsic attenuation law and the attenuation model may be an intrinsic attenuation model.

The corrected changes in the attribute may be produced by: producing a plurality of modeled changes in the attribute between the respective pairs of depth levels using the information, and correcting the estimated changes in the attribute with the modeled changes in the attribute.

The corrected changes in the attribute may be produced by estimating and applying a correction factor from the modeled changes in the attribute to each of the estimated changes in the attribute.

The correction factor may be applied to the amplitude and/or phase spectra of each of the estimated changes in attribute to produce corrected change in attribute amplitude and/or phase spectra.

The correction factor may be a stabilized correction factor. The correction factor may be an inverse filter that may remove all or part of an interference effect. The interference effect could, for example, be modeled as a convolution with a set of spikes with their amplitudes estimated based on the acoustic impedance contrasts estimated from the well logs. The discrete Fourier Transform of this spike series, i.e. the transfer function of the interference model, is very likely to contain zeroes. The inverse filter to correct for this interference may be implemented as a Wiener filter, and may require stabilization, e.g. a water level or a small amount of damping on the zero lag in the normal equations. This is the same kind of filter stabilisation that would typically be needed when applying a predictive deconvolution or other Wiener filter in seismic processing.

The changes in attribute of the wavefield between respective pairs of depth levels may comprise amplitude and/or phase spectra. Measurements using only the amplitude spectra may typically have a better signal-to-noise ratio than those measurements using only phase spectra. Using both in combination may give increased robustness and/or a more reliable uncertainty estimate.

The method may further comprise comparing the corrected changes in attribute amplitude and/or phase spectra with expectations from the Kramers-Kronig relations.

Outputting the attenuation model may comprise outputting the attenuation model with uncertainties estimated from the model fit for amplitude and/or phase spectra.

The method may further comprise, when the VSP data has been gathered by receivers placed at the depth levels, correcting for receiver coupling by: separating the upgoing and downgoing wavefields of the wavefield, estimating a change due to receiver coupling in an attribute sensitive to receiver coupling of the downgoing and upgoing wavefields respectively, calculating and applying modified correction factors for upgoing and downgoing wavefields, and estimating the attenuation model based on using modified correction factors to correct estimated changes due to receiver coupling in the attribute sensitive to receiver coupling.

The upgoing and downgoing wavefields may be separated by median filtering.

In VSP measurements, the wavefield may be measured using receivers such as geophones or accelerometers. The receivers may be attached either to a casing of, or directly to, a formation, such as a borehole wall. The receivers may be clamped or cemented in place. The quality of the recordings made by the receivers may depend on the receivers making a good contact with the formation. Such a contact may allow elastic waves to pass into the receiver with as little distortion as possible.

In the case of perfect coupling (i.e. a perfectly elastic communication between the receiver and the formation) the coupling could be represented by a unit spike at time zero. Such an ideal scenario may still require be a filter due to the impulse response of the receiver itself (commonly known as the “instrument response”). However, this is not considered as part of the coupling, and as long as the instrument response is linear, time-invariant, and common to all of our receivers it may cancel.

In non-ideal cases, where the sensor may be imperfectly clamped or cemented to the formation, there may be signal distortion due to this imperfect clamping. Such distortion may be referred to as receiver coupling. Receiver coupling may be removed from the VSP dataset.

Receiver coupling may be represented by a linear time-invariant filter with zero initial conditions and zero-point equilibrium. The attribute sensitive to receiver coupling of the downgoing and upgoing wavefields may be corrected for receiver coupling at the depth levels. This attribute may be a transfer function or an impulse response.

Estimating the change due to receiver coupling in the attribute sensitive to receiver coupling of the downgoing and upgoing wavefields respectively may comprise estimating a coupling spectral ratio using the following expression

$${\vert \frac{{C}_{1}}{{C}_{2}} \vert}^{2} ∼ \sqrt{\frac{{\hat{P}}_{1 D}}{{\hat{P}}_{2 D}} \cdot \frac{{\hat{P}}_{1 V}}{{\hat{P}}_{2 V}}} \cdot {\vert \frac{{\hat{J}}_{2}}{{\hat{J}}_{1}} \vert}^{2}$$

wherein

$${\vert \frac{{C}_{1}}{{C}_{2}} \vert}^{2}$$

represents the coupling spectral ratio,

$$\sqrt{\frac{{\hat{P}}_{1 D}}{{\hat{P}}_{2 D}} \cdot \frac{{\hat{P}}_{1 V}}{{\hat{P}}_{2 V}}}$$

represents the spectral power ratios for downgoing and upgoing waves respectively,

$${\vert \frac{{\hat{J}}_{2}}{{\hat{J}}_{1}} \vert}^{2}$$

represents the source spectral ratio.

The method may also comprise: applying VSP pre-processing, including a broad bandpass filter, appropriate deconvolution of signatures, trace editing, and stacking for each depth level; choosing time windows to include first arrivals; processing VSP with standard processing for velocity and time-depth relation estimation; calibrating sonic and density well logs; and editing and infilling well logs to build a detailed elastic model from the start of the first time window to the end of the last time window prior to building said estimate of the transfer functions.

The method may also comprise: removal of multiples and ghosts from said VSP during pre-processing, wherein said removal comprises deconvolution. Multiple/ghost arrivals may be present in the measured VSP dataset.

The method may also comprise: estimating the transfer functions by match filtering.

A second aspect of the present invention relates to a method of obtaining an attenuation model estimate for a vertical seismic profile (VSP), comprising:
receiving a vertical seismic profile dataset;
building an estimate of the transfer function between levels based on the VSP dataset;
inputting information for modeling local interference and correcting the estimated transfer function;
choosing and fitting an effective attenuation law to the corrected transfer functions;
outputting an effective attenuation model;
   characterized in that
   said input information comprises measured well log and/or borehole information to model interference from interfaces near the receiver levels and choosing and fitting an attenuation law to transfer functions corrected for this interference.

A third aspect of the present invention relates to the method of the second aspect, comprising:
inputting said information for modeling estimated transfer functions between each pair of levels after inputting information for modeling interference and correcting the estimated transfer function;
correcting the estimated transfer functions for transmission effects between the receiver levels with said modeled transfer functions;
choosing and fitting an intrinsic attenuation law to the corrected transfer functions; and
outputting an intrinsic attenuation model.

A fourth aspect of the present invention relates to the method of the second or third aspect, comprising:
applying VSP pre-processing, including a very broad bandpass filter, appropriate deconvolution of signatures, trace editing, and stacking for each depth level;
choosing time windows to include first arrivals;
processing VSP with standard processing for velocity and time-depth relation estimation;
calibrating sonic and density logs; and
editing and infilling logs to build a detailed elastic model from the start of the first time window to the end of the last time window prior to building said estimate of the transfer function between levels based on the VSP dataset.

A fifth aspect of the present invention relates to the method of the fourth aspect, comprising:

removal of multiples and ghosts from said VSP during pre-processing, wherein said removal comprises deconvolution.

A sixth aspect of the present invention relates to the method of the fourth or fifth aspect, comprising:

estimating the transfer function between levels by match filtering.

A seventh aspect of the present invention relates to the method of the sixth aspect, comprising:

estimating and applying a stabilized correction factor from the modeled transfer functions to the amplitude and phase spectra of the transfer function for each receiver pair.

An eighth aspect of the present invention relates to the method of the fifth aspect, comprising:

comparing corrected transfer function amplitude and phase spectra with expectations from the Kramers-Kronig relations.

A ninth aspect of the present invention relates to the method of the fourth or fifth aspect, comprising:

estimating attenuation between levels by stabilized or unstabilized spectral ratios.

A tenth aspect of the present invention relates to the method of the second aspect, comprising:
omitting reflection losses and including transmission losses within a user-specified distance or travel time of the receiver; and
repeating steps according to the sixth to eighth aspects using the said stabilized correction factor or according to the ninth aspect.

An eleventh aspect of the present invention relates to the method of the tenth aspect, comprising:

outputting an effective attenuation model estimate with uncertainties estimated from the model fit for both amplitude and phase spectra according to the seventh aspect.

A twelfth aspect of the present invention relates to the method of the eighth or ninth aspect, comprising:

outputting of the intrinsic attenuation model estimate with uncertainties estimated from the model fit for both amplitude and phase spectra according to the seventh aspect.

A thirteenth aspect of the present invention relates to the method of the second or third aspect, comprising:
determining variations in a time-frequency- or time-frequency domain attribute sensitive to attenuation;
estimating an interference correction factor;
estimating a correction for transmission losses based on said variations; and
estimating the attenuation between two receiver levels in a VSP dataset based on said variations.

A fourteenth aspect of the present invention relates to the method of the twelfth aspect, comprising:

estimating said correction by means of rise-time or peak amplitude for a time-domain attribute, center frequency shift for a frequency-domain attribute, wherein dominant frequency shifts or instantaneous frequency shifts can be used in either the Fourier frequency domain, or in combination with other time-frequency transforms, wherein said other time-frequency transforms can include Gabor transform, Stockwell/S-transform, synchrosqueezing, Complete Ensemble Empirical Mode Decomposition (CEEMD) or Continuous wavelet transform (CWT).

A fifteenth aspect of the present invention relates to the method of the eleventh or twelfth aspect, comprising:
correcting for receiver coupling at selected intervals by separating the upgoing and downgoing wavefields,
calculating and applying modified correction factors for upgoing and downgoing arrival windows;
estimating the coupling spectral ratio using the following expression

$${\vert \frac{{C}_{1}}{{C}_{2}} \vert}^{2} ∼ \sqrt{\frac{{\hat{P}}_{1 D}}{{\hat{P}}_{2 D}} \cdot \frac{{\hat{P}}_{1 V}}{{\hat{P}}_{2 V}}} \cdot {\vert \frac{{\hat{J}}_{2}}{{\hat{J}}_{1}} \vert}^{2}$$

wherein

$${\vert \frac{{C}_{1}}{{C}_{2}} \vert}^{2}$$

represents the coupling ratio,

$$\sqrt{\frac{{\hat{P}}_{1 D}}{{\hat{P}}_{2 D}} \cdot \frac{{\hat{P}}_{1 V}}{{\hat{P}}_{2 V}}}$$

represents the spectral power ratios for downgoing and upgoing waves respectively,

$${\vert \frac{{\hat{J}}_{2}}{{\hat{J}}_{1}} \vert}^{2}$$

represents the source spectral ratio; and
estimating the attenuation models based on using the coupling spectral ratio to correct the spectral ratio estimates.

In another aspect, the invention provides a data processing apparatus configured to perform any of method of any of the aspects and optionally the preferred features thereof as described above.

In another aspect, the invention provides a computer program product comprising instructions that when executed on a data processing apparatus will configure the data processing apparatus to perform the method of any of the aspects and optionally the preferred features thereof as described above.

### DETAILED DESCRIPTION OF THE INVENTION

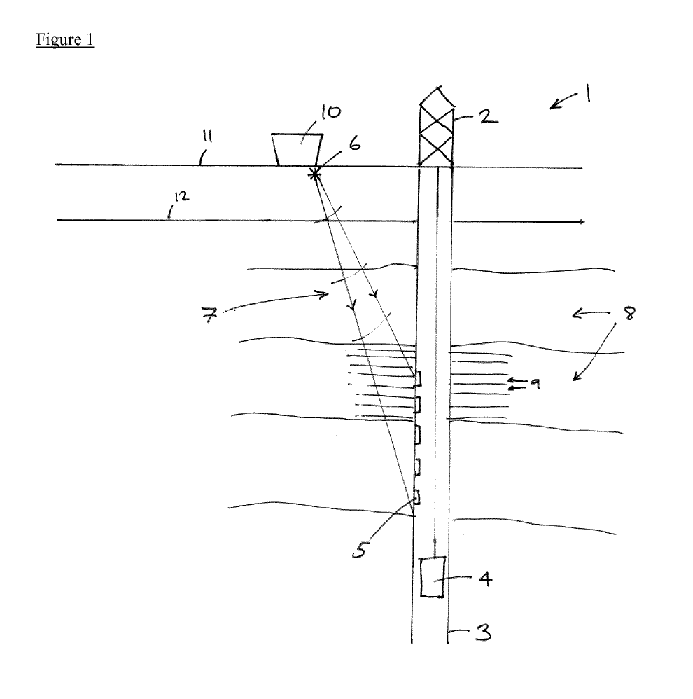

Certain preferred embodiments will now be described by way of example only and with reference to the accompanying drawing, in which FIG. 1 shows a schematic view of an exemplary VSP dataset-gathering apparatus.

Regarding FIG. 1, the VSP dataset-gathering apparatus 1 comprises a rig 2 positioned above a well bore 3. Descending into the well bore 3 from the rig 2 is a wireline logging tool 4 which is able to collect well log data (which may comprise information correlating depth to rock-type). The wireline logging tool records the depth of various geological layers, which include both main geological layers 8 and fine geological layers 9. Coupled to the side of the well bore 3 is a plurality of receivers 5. Each receiver 5 is placed at a selected known depth. A seismic source 6, which may be at or near a vessel 10 on the sea surface 11 above the seabed 12, generates seismic wavefields 7. The wavefronts of the seismic wavefields 7 are detected by the receivers 5, and a corresponding VSP dataset recorded. The well log data and the VSP dataset may be used in the method of the invention.

The method according to the present invention uses sonic, density and, if necessary, shear wave sonic well logs to estimate the local reflectivity around the receiver and compensate for the interference these effects cause to the attenuation estimates.

The advantages and improvements achieved by this invention include the following aspects:
More accurate estimates of effective Q.
Higher resolution estimates of effective Q.
Local separation of effective Q and intrinsic Q. Effective Q is needed for most imaging applications. Intrinsic Q is needed for use as an interpretive attribute.
Correction of Q estimates for variable receiver coupling, leading to more accurate Q estimates.

Improved resolution and accuracy in both effective and intrinsic Q values may allow their use as reservoir attributes. Intrinsic Q has the potential to discriminate between lithologies. Q may also be sensitive to clay content in sands, gas saturation (although not necessarily in a unique way), overpressure, fracturing, and several other geological effects. Higher quality and resolution Q estimates allows better understanding of the most important controls on seismic Q at VSP frequencies and scales. If local wavelet estimate based methods for estimating Q from surface seismic, or alternatively viscoelastic or viscoacoustic full waveform inversion methods prove successful, this method applied on VSPs will allow the building up of a database of Q at seismic frequencies and scales as a function of the various different variables thought to control Q—where there is much literature on this, based largely on laboratory experiments conducted often at ultrasonic or even higher frequencies.

Improved effective Q estimates will help in maximizing value from viscoacoustic and viscoelastic migrations developed within the seismic imaging research community. The difficulty of estimating sufficiently accurate Q models to go into these migrations is a limitation on the value they can add. Estimating more accurate Q models at wells is a first step to improving, understanding, and calibrating Q estimates made from surface seismic.

To achieve the aims of the invention, the main aspects are outlined in the following:
1. The correction of Q estimates from zero offset VSP for spectral interference due to local reflectivity, including fine layering, close to the receivers.
2. Correction of Q estimates for receiver coupling, using the upgoing wavefield, combined with the above correction.
3. The model-based separation of intrinsic and scattering attenuation applied to Q estimates from VSP. This separation is important as it is the combined effect of scattering and absorption that is needed as input to seismic data processing, but it is the absorption itself that has most potential as an attribute in exploration.
4. Use of the phase part of the transfer function estimate to quality control Q estimates.
5. Use of the near source measurements to estimate an overall effective Q down to the first receiver (useful for seismic processing).
6. Estimation and a better understanding of the form of the attenuation law. Understanding the attenuation laws, and the physical mechanisms they imply, that apply at seismic scales and frequencies for different lithologies, fluid saturation and pore spaces, yields information for understanding and using Q values away from well control.

The same well-log based reflectivity models can be used to approximately separate scattering and intrinsic attenuation. This is done by building a detailed model of the interval covered by the VSP. This can be done using invariant embedding, (Kennett, 1982), (or if a zero offset approximation suffices, then simpler methods, e.g. Ganley (1981), can be used), one can then use the approximate relation that intrinsic 1/Q and scattering 1/Q are additive (Lerche and Menke, 1986) to separate the scattering and absorption components of the measured attenuation. This modeling if carried out sufficiently accurately and if quality controlled in comparison with the field data will also gradually yield a better understanding of the variation with frequency of scattering attenuation and the accuracy of the additivity assumption. If necessary the separation can be updated iteratively by means of viscoelastic modeling.

The correction for the effects of the local reflectivity improve the accuracy of the estimates allowing more closely-spaced pairs of receivers to be included in the inversion, resulting in increased resolution. This in turn results in easier correlation between Q values and particular geological units, thus increasing understanding of seismic absorption, and potentially allowing its use in the future more as an interpretational attribute, given improvement in Q estimation technology from surface seismic.

If the reflectivity correction is successful, which may depend both on geological structure around the well, and the quality and extent of the well log data available, this may allow the upgoing wave to be used successfully for the correction for differences in the frequency dependence of the receiver coupling response in the way suggested, but not successfully carried out, by Raikes and White (1984). This again leads to more accurate, and therefore higher resolution Q estimates, and a better understanding of the form of the appropriate attenuation law for each lithology and geological setting.

If causality and linearity in wave propagation is assumed, it is known that the phase and amplitude parts of an attenuation operator should be related by the Kramers-Kronig relations (e.g. Futterman, 1962). Given that the full transfer function can be estimated (Raikes and White, 1984) not just the amplitude part, this can be made use of as a quality control. This yields a method for checking that intrinsic attenuation is really being measured and that the non-absorptive effects have been separated out from the absorptive effects. If the relations are not obeyed within some user defined error limit, then that particular pair of VSP receivers can be excluded from the inversion and/or flagged for further investigation. This yields a more objective criterion for the rejection of bad data.

In addition to the features described above the best features of several other published methods for Q estimation from VSP will be combined in order to allow a high-resolution intrinsic 1/Q estimate that can be related directly to the lithology and pore fluid content to be made. It is the correction for all of these effects in combination that add value, the use of the well logs to correct for reflectivity and the subsequent corrections for coupling—which was previously not possible, allowing intrinsic Q to be estimated with greater resolution and confidence than ever before, and three different Q estimates to be obtained (of which two are approximately independent). One is an intrinsic Q estimate, which has the potential, if it can also be estimated from surface seismic, to be used as an interpretive attribute away from the well, the second is a so-called effective Q estimate that combines intrinsic attenuation, and scattering effects and which is suitable for use in seismic processing and imaging. The third is the scattering attenuation. The improved accuracy and resolution as well as the separation out of the intrinsic attenuation allows the use of Q in more interpretive applications than ever before, and gives a much better chance to understand controls on seismic Q as observed on the scales and frequencies observed in surface seismic and VSP data.

Note that according to the present invention, the downgoing wavefield need not be separated from the upgoing in making the initial Q estimate. This is not necessary as the removal of interfering part of the upgoing wavefield is included in the reflectivity correction. Attempting to perform wavefield separation before Q estimation, although this improves results from the standard technique, it will still remain unknown how much of the local interference was removed and how much was left in. Avoiding the wavefield separation has the advantage of increasing vertical resolution, since wavefield separation on VSP data involves the combination of data from neighbouring levels. Including the reflectivity correction, equation (1) becomes:

$$A ( ω ) = {k}_{1} {A}_{0} ( ω ) \frac{{R}_{0} ( ω )}{R ( ω )} exp [ - α ( ω ) ( z - {z}_{0} ) ] = {k}_{1} {A}_{0} ( ω ) [ \frac{{R}_{0} ( ω )}{R ( ω )} ] exp [ \frac{- ω ( t - {t}_{0} )}{2 Q} ] \qquad ( 4 )$$

Where: Rₒ(ω) and R(ω) are approximations to the spectral interference due to the reflectivity around the receiver at depths zₒ and z respectively. Rₒ(ω) and R(ω) may be convolution approximations to the spectral interference due to the reflectivity around the receiver at depths zₒ and z respectively. As a first approximation these could be composed of a reflection coefficient series in travel time that is constructed using well logs to calculate the reflection coefficients just below the receiver causing interfering upgoing reflections arriving within the window used for spectral analysis after the direct wave at a given depth. These reflections from just below the receiver should be the most significant part of the interference as they have only reflected once. It may be necessary in some cases to include downgoing reflections from just above the receiver, and potentially also transmission losses and higher order multiples into the reflectivity corrections, where strong contrasts in elastic properties near the receiver make this necessary. However, the correction from just below the receiver should remove the largest source of interference.

In some cases, where the upgoing reflected energy is mostly removable by the wavefield separation, or where the well log based model is not doing an adequate job of predicting the relative strength of the interference, it may still be advantageous to separate the downgoing wavefield prior to applying a modified correction to the downgoing arrival for residual interfering upgoing reflections. In such cases the wavefield separation filter also needs to be applied to the estimate of the interference prior to making the correction.

Note that although equation 1 as formulated here includes an approximation for low absorption, for simplicity, where necessary an attenuation would be chosen which is valid for lossy media, see e.g. O'Connell and Budianksy (1978).

This may be important, since if inverting for thinner layers it is expected to obtain more extremes in the attenuation values in the model (i.e. because the present model may include localised higher attenuation thin layers) than when inverting for a coarser model. Kjartansson (1979)'s CQ model may be chosen, such that the definition of Q based on mean energy loss per cycle and therefore equation (5) may bes equally valid for lossy media (O'Connell and Budiansky, 1978).

Another embodiment of the invention could use spectral ratios, which, unless they were complex (e.g. Cheng and Margrave (2008)), would lose the advantage of the quality check via the use of the Kramers-Kronig relations, i.e. the question arises whether the phase and amplitude parts of the match filter relate to one another in the correct way to indicate that the loss of high frequencies is due to the Q model assumed in the inversion.

After the initial Q estimates have been made, suitable up and downgoing events can be isolated (e.g. via time windowing), and a modification of the method of Raikes and White (1984) used to estimate the coupling spectra of the receivers. The modification involves including a well-log model-based correction for local reflectivity on the spectral estimates based on the upgoing and downgoing events. The upgoing event requires a slightly different correction factor than the downgoing event. The success of this approach is likely very sensitive to data quality and deviations from the assumptions of the model. In cases where this yields sensible results then these can be fed back into the original process and the initial Q estimates corrected for any frequency-dependent variation in receiver coupling.

Also according to the present invention, and in addition to raw zero offset VSP datasets, additional field measurements can include density and sonic logging and possibly sonic shear data. Density logging is primarily used to obtain a record of bulk density as a function of depth in a borehole. Bulk density is dependent on the mineral density of the rock and fluid in the pore spaces. The measurement is generally carried out using a radioactive source emitting gamma rays which is lowered into the borehole. The instrumentation package will also contain at least one gamma ray detector placed at given distances from the source. The signal reaching a detector, as a result of Compton scattering with electrons in the formation rock, can be directly correlated to the formation's bulk density. Similarly, a sonic logging system generally consists of at least one acoustic source and several axially placed receivers for determining the formation's interval transit time, or capacity to transmit seismic waves. The transit time is then correlated to the local lithology, rock type, porosity and pore fluid. Borehole sonic shear (S-wave) measurements can also be performed for determining travel time and refractive properties, anisotropy or wavespeeds, of a formation. Other well log or borehole information may comprise imaging for visual characterization of formation properties.

The main steps and embodiments of the method according to the present invention is outlined in the following steps:
0. Perform seismic VSP and supporting (seismic/sonic log, density log and shear wave sonic well log data) measurements.
1. Receive a raw zero offset VSP dataset, observers logs, signature estimates, and P-wave, S-wave (optionally) and density logs. Note that in slightly different embodiments this invention may be useable on other types of VSP data including walkaway VSP, but a zero offset VSP is often the most advantageous for the estimation of Q. If S-wave logs are not available, then a synthetic S-wave log can be generated from rock physics relations. For example if a zero offset approximation to the transfer function is used in step 8, then S-wave logs are no longer necessary.
2. Apply VSP pre-processing, including a very broad bandpass filter, appropriate deconvolution of signatures, trace editing, and stacking for each depth level. Trace editing may comprise using only windowed portions of a trace. Optimization of this pre-processing will typically require some testing, for example removal of the traces with the highest noise levels. For example there may be small time shifts which require correction, or in some cases it may be better not to apply a designature or stacking.
3. Pick time windows to include first arrivals. The optimal length for the analysis window is a key parameter for testing. There is a trade-off here between resolution and accuracy. A short window provides fewer points in the frequency domain, and thus poorer accuracy, whilst a longer window provides more points in the frequency domain but is open to contamination by the effects of upgoing events which introduce peaks and notches into the spectrum and have experienced a slightly different effective Q. Also the signal to noise ratio of the downgoing waves is often at its highest around the start of the direct arrival.
4. Process VSP with standard processing for velocity and time-depth relation estimation. In practice, there is no single standard processing for these purposes. The aim of this step is to provide data for calibration of the sonic, not for use later in the process, after step 6 we revert to the data output from step 2.
5. Calibrate sonic and density logs (time-depth only, i.e. stretch and squeeze). The log data are just stretched and squeezed with an appropriate correction (the choice of correction type is dependent on the petrophysicist's judgement of the likely cause of the drift) such that their integrated travel time agrees with the picked arrival times from the VSP. The sonic and density values themselves remain unchanged as is typical for logs to be used in the generation of synthetic seismograms.
6. Edit and infill logs to build a detailed elastic model from the start of the first time window to the end of the last. There are often problematic zones in well logs. These should be infilled using empirical or rock physics based relations constrained by the fact that the integrated travel time through the sonic log must remain consistent with the VSP traveltime picks. In cases where strong reflectors in the overburden generate peg-leg multiples with a short enough delay to interfere with the downgoing primary, and where well logs are available in the overburden, it may be desirable to include as much as possible of the overburden in the modeled transfer functions for reflectivity and stratigraphic attenuation correction.
7. Optionally, deconvolve out the seabed and free surface multiples from the output from step 2. If a long time window is used in the analysis it may be desirable to deconvolve out the seabed multiple and even the free surface multiple from the output from step 2. This will likely only be necessary for VSP datasets where both VSP and log data start very near the seabed and/or where the seabed is shallow, as the use of long time windows in this analysis is likely to smear out attenuation and lead to contamination from reflected events which have traveled a different path to the downgoing events. Deghosting may also be advantageous.
8. Calculate the model transfer function (amplitude and phase spectrum) between the uppermost receiver level and each deeper receiver level, or between each pair of receiver levels. In some cases it may be advantageous that not all levels are taken into account. One likely implementation for the calculation of the transfer function is to use a propagator matrix, with invariant embedding, and some other numerical algorithms used in reflectivity modeling. Dependent on whether or not one is at step 8, 15, or 17, a different version of the transfer function is required and can be calculated. It is a matter for testing how accurate a modeling algorithm is required for this step, for example the estimation of the transfer function here simplifies considerable when considering only zero offset (i.e. horizontal slowness (p)=0). Other modeling methods could also be used for the calculation of this transfer function. For embodiments involving well deviation or walkaway type geometries an elastic modeling method that is valid for non-zero p will be required. The reflectivity correction (modeled transfer function) may be iteratively updated by updating the model for this to include the Q estimate from the previous iteration of the inversion. This is more important for very lossy/absorptive media.
9. Estimate the transfer function between levels from the data output from 2 or 7 using e.g. match filtering. This step can be performed as described by Raikes and White (1984). An alternative embodiment here could use spectral ratios or another method for the estimation of attenuation, but this would lose some of the advantages of the method.
10. Estimate and apply a stabilized correction factor from the modeled transfer functions (from step 8) to the amplitude and phase spectra of the transfer function for each receiver pair. This is a stabilized deconvolution, possibly applied as a stabilized spectral division in the frequency domain.
11. Compare the corrected transfer function amplitude and phase spectra with expectations from the Kramers-Kronig relations. This is a quality check to see whether it is plausible that intrinsic attenuation is responsible for the corrected transfer function that has been estimated. It applies when the input data comes from step 8 or 17, rather than from step 15, in which case this may not be a valid quality check.
12. Quality control transfer function estimates, edit, select a minimum receiver depth separation (resolution), and select an attenuation law to fit to the transfer functions and estimate the bandwidth over which to fit it (ideally based on objective and consistently selected criteria). For some types of geology it may be necessary to use a different attenuation law, e.g. carbonate vs. sandstone. The choices of the bandwidth, and receiver depth separation are likely important parameters. The attenuation law should be one which is reasonably based on previous observations of high quality VSP data in the kind of lithology present.
13. Fit attenuation law to amplitude or phase spectra (or both), optionally simultaneously, of transfer function. This should be done using a stabilized inversion for all good receiver pairs with a large enough receiver separation. This stabilized inversion likely needs to be robust, although as a first estimate a least-squares fit could be useful. It may in some cases be necessary to go back to the data if results here do not make sense geologically. This inversion could potentially be Bayesian. The output model could be discretized based on a horizon based macro-model from formation tops and seismic horizons, and could be constructed as layers of a constant thickness, or could be a horizontal layering with layer boundaries defined at the receiver depths, or a horizontal layering with layer boundaries defined arbitrarily within the receiver interval. This inversion is, in some respects, similar to a 1-D tomography problem.
14. Output intrinsic attenuation model estimate with uncertainties estimated from the model fit for both amplitude and phase spectra in step 13. These are the intrinsic attenuation estimates. Note that the uncertainty is derived from the global fit to the model not to the fitting of individual attenuation models to corrected transfer function estimates. This is because for a zero offset VSP geometry many different source and receiver pairs typically sample the attenuation (both effective and intrinsic) of any particular small depth interval. This is one key advantage of a zero offset VSP geometry.
15. Optionally, repeat step 8 omitting reflections but not transmission losses from all but those interfaces within a user-specified distance or travel time of the receiver. Then repeat steps (10-13) using the new stabilized correction factor. A useful feature of reflectivity modeling (Kennett, 1982) is the ability to deselect reflections from particular interfaces. This can be used to remove the effect of most of the stratigraphic attenuation from the modeled correction factor, whilst still allowing the model-based correction for the local interference effects on the transfer function estimate. Testing will be required to discover the optimum time or depth range around the receiver to include reflections from in the transfer function for the correction factor. This useful feature also applies to the zero offset VSP modelling method of Ganley (1981).
16. Optionally, output effective attenuation model estimate with uncertainties estimated from the model fit for both amplitude and phase spectra in step 13). The output from step 15 should be an approximate estimate of the effective attenuation. This is typically what is needed for Q compensation purposes or for correcting AVO (amplitude versus offset) responses for overburden high frequency losses, but with the advantage compared to standard VSP Q estimates that the effects of local interference on the spectrum have been removed. The intrinsic Q estimation is potentially more useful as an attribute or for the approximate correction of AVO responses for contrast in Q at the interface.
17. Optionally correct for receiver coupling at selected intervals by windowing the pairs of up and downgoing arrivals, calculating and applying modified correction factors for upgoing and downgoing arrival windows and then applying the method of Raikes and White (1984) to the resulting transfer functions. Use these coupling estimates to correct the results of 14 and 16 for receiver coupling. For some datasets there may be problems with receiver coupling, and resulting frequency-dependent variations in the amplitude and phase response of the sensor. In one embodiment of this invention it could be possible to apply upgoing/downgoing wavefield separation by means of, for example, median filtering instead of just isolating the relevant events using time windows. Then appropriate transfer functions are calculated for reflectivity corrections are for the appropriate reflections in the upgoing wavefield and equation 16 from Raikes and White (1984) is used to estimate the receiver coupling. This estimate can then be deconvolved out of the transfer function estimates from step 11.
18. End—final product(s) comprising high resolution estimates of intrinsic and effective attenuation from VSP.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the scope of the appended claims.

While the invention has been illustrated and described in detail in the drawings and foregoing description, such illustration and description are to be considered illustrative or exemplary and not restrictive and it is not intended to limit the invention to the disclosed embodiments. The mere fact that certain measures are recited in mutually different dependent claims does not indicate that a combination of these measures cannot be used advantageously.

### REFERENCES

Aki, K., and Richards, P. G. 1980. Quantitative Seismology. Freeman and Co., New York.
Amundsen, L., and Mittet, R. 1994. Estimation of phase velocities and Q-factors from zero-offset, vertical seismic profile data: Geophysics, 59, 500-517.
Barnes, C. 2010. Anisotropic anelastic full waveform inversion: Application to North Sea offset VSP data. SEG Denver Annual Meeting, Expanded Abstract.
Blias, E. 2012. Accurate Q-factor estimation from VSP data: Geophysics, 77, (3), WA149-WA156.
Carter, A. J. 2003. Seismic attenuation estimation from surface seismic reflection surveys—an exploration tool? Unpublished Ph.D. thesis, School of Earth Sciences, University of Leeds, UK.
Dillon, P. B. 1991. Q and upward extension of VSP data through the energy-flux theorem. First Break 9(6), 289-298.
Dietrich, M., and Bouchon, M. 1985. Measurements of attenuation from vertical seismic profiles by iterative modeling: Geophysics, 50, 981-949.
Engelhard, L. 1996. Determination of seismic-wave attenuation by complex trace analysis. Geophysical Journal International, 125, 608-622.
Ferguson, R. J., Margrave, G. F., and Hall, K. W. 2009. Gabor domain analysis of Q in the near surface. CREWES Research Report, Volume 21.
Futterman, W. I. 1962. Dispersive body waves. Journal of Geophysical Research, 67, 5279-91.
Ganley, D. C. 1981. A method for calculating synthetic seismograms which include the effects of absorption and dispersion. Geophysics, 46, 1100-1107.
Goloshubin, G., and Bayuk, I. 2010. Application of amplitude and spectral ratio methods for estimation of attenuation from VSP: SEG Denver Annual meeting, Expanded Abstract.
Haase, A. G., and Stewart, R. T. 2005. Estimating seismic attenuation Q by an analytical signal method. SEG Expanded Abstracts.
Hackert, C. L., and Parra, J. O. 2004. Improving Q estimates from seismic reflection data using well-log-based localized spectral correction: Geophysics, 69, 1521-1529.
Harris, P. E., Kerner, C., and White, R. E. 1997. Multichannel estimation of frequency-dependent Q from VSP data: Geophys. Prospect., 45(1), 87-110.
Jacobsen, R. S., 1987. An investigation in to the fundamental relationship between attenuation, phase dispersion, and frequency using seismic refraction profiles over sedimentary structures: Geophysics, 52, 72-87.
Jannsen, D., Voss, J., and Theilen. F. 1985. Comparison of methods to determine Q in shallow marine sediments from vertical reflection seismograms. Geophys. Prospect., 33, 479-497.
Kan, T. K., Batzle, M. L., and Gaiser, J. E. 1983. Attenuation measured from VSP: Evidence of frequency-dependent Q. SEG Abstract, 589-590.
Kennett, B. L. N. 1982. Seismic wave propagation in stratified media: Cambridge University Press, UK.
Kerner, C., and Harris, P. 1994. Scattering attenuation in sediments modelled by ARMA processes—Validation of simple Q models: Geophysics, 59(12), 1813-1826.
Lerche, I., and Menke, W. 1996. An inversion method for separating apparent and intrinsic attenuation in layered media: Geophysical Journal of the Royal Astronomical Society, 33, 333-347.
Kjartansson, E. 1979. Constant Q-wave propagation and attenuation. Journal of Geophysical Research, 84, 4737-4748.
Mateeva, A. 2003. Thin horizontal layering as a stratigraphic filter in absorption estimation and seismic deconvolution: Ph.D. thesis, Center for Wave Phenomena, Colorado School of Mines, Colorado, USA. Report no. CWP-462.
Newman, P. J., and Worthington, M. H., 1982. In-situ investigation of seismic body wave attenuation in heterogeneous media: Geophys. Prospect., 30, 377-400.
Ning, T., and Lu, W. 2010. Improve Q estimates with spectrum correction based on seismic wavelet estimation: Applied Geophysics, 7(3), 217-228.
O'Connell, R. J., and Budiansky, B. 1978. Measures of dissipation in viscoelastic media. Geophysical Research Letters, 5(1), 5-8.
O'Doherty, R. F., and Anstey, N. A. 1971. Reflections on amplitudes: Geophys. Prospect., 19, 430-458.
Parra, J. O., Hackert, C. L., Wilson, L, Collier, H. A., and Thomas, J. T. 2006. Q as a lithological/hydrocarbon indicator: from full waveform sonic to 3D surface seismic. US Department of Energy Final Project Report. DOE Contract number DE-FC26-02NT15343.
Pujol, J. and Smithson, S. 1991. Seismic attenuation in volcanic rocks from VSP experiments. Geophysics, 56, 1441-1455
Raikes, S. A., and White, R. E. 1984. Measurements of earth attenuation from downhole and surface seismic recordings. Geophysical Prospecting, 32, 892-919.
Sams, M. S., Neep, J. P., Worthington, M. H., and King, M. S. 1997. The measurement of velocity dispersion and frequency-dependent intrinsic attenuation in sedimentary rocks. Geophysics, 62, 1456-1464.
Schoenberger, M., and Levin, F. K., 1974. Apparent attenuation due to intrabed multiples: Geophysics, 39(3), 278-291.
Schoenberger, M., and Levin, F. K., 1978. Apparent attenuation due to intrabed multiples II: Geophysics, 43(4), 730-737.
Spencer, T. W., Edwards, C. M., and Sonnad, J. R. 1977. Seismic wave attenuation in non-resolvable cyclic stratification. Geophysics, 42, 939-949.
Spencer, T. W., Sonnad, J. R., and Butler, T. M. 1982. Seismic Q—stratigraphy or dissipation? Geophysics, 47, 16-24.
Stewart, R. R., Huddlestone, P. D., and Kan, T. K. 1984. Seismic versus sonic velocities: A vertical seismic profiling study: Geophysics, 49, 1153-1168.
Tonn, R. 1991. The determination of seismic quality factor Q from VSP data: A comparison of different computational methods. Geophys. Prospect., 39, 1-27.
Toverud, T. and Ursin, B. 2005. Comparison of seismic attenuation models using zero-offset vertical seismic profiling (VSP) data: Geophysics, 70(2), F17-F25.
Wang, Y. 2008. Seismic inverse Q filtering. Blackwell Publishing.
White R. E. 1992. The accuracy of estimating Q from seismic data: Geophysics, 57(11), 1508-1511.
Worthington, M. H., and Hudson, J. A. 2000. Fault properties from seismic Q. Geophys. J. Internat., 143, 937-944.
Yang, Y., Li, Y. and Liu, T. 2009. 1D viscoelastic waveform inversion for Q structures from the surface seismic and zero-offset VSP data. Geophysics, 74(6), WCC141-WCC148.
Cheng, P., and Margrave, G. 2008. Complex spectral ratio method for Q estimation. CREWES Research Report, University of Calgary, Canada, volume 20

I claim:

1. Method of obtaining an attenuation model estimate for a vertical seismic profile (VSP), comprising:
receiving a vertical seismic profile dataset, the VSP dataset having been generated by recording a wavefield at a plurality of depth levels;
building an estimate of a plurality of changes in an attribute of the wavefield sensitive to attenuation between respective pairs of depth levels based on the VSP dataset;
producing a plurality of corrected changes in the attribute between the respective pairs of depth levels by modeling local interference of the wavefield from interfaces near each of the depth levels using information comprising measured well log and/or borehole information and correcting the estimated changes in the attribute for this interference;
choosing and fitting an attenuation law to the corrected transfer functions; and
outputting an attenuation model.

2. Method according to claim 1, comprising separating upgoing and downgoing wavefields of the wavefield, and correcting the estimated changes in the attribute of the wavefield for the downgoing wavefield.

3. Method according to claim 1, wherein modeling local interference of the wavefield from interfaces near each of the depth levels comprises removing reflections of the wavefield from the interfaces within a user-specified distance or travel time of each depth level, but not removing scattering losses of the wavefield.

4. Method according to claim 1, wherein the attenuation law is an effective attenuation law and the attenuation model is an effective attenuation model.

5. Method according to claim 1, comprising:
producing the plurality of corrected changes in the attribute by also modeling scattering effects of the wavefield between the respective pairs of depth levels using the information comprising well log and/or borehole information, and
correcting the estimated changes in the attribute for these scattering effects.

6. Method according to claim 5, wherein modeling local interference of the wavefield from interfaces near each of the depth levels comprises removing reflections from the interfaces within a user-specified distance or travel time of each depth level, and modeling scattering effects of the wavefield between the respective pairs of depth levels comprises removing scattering losses of the wavefield between the respective pairs of depth levels.

7. Method according to claim 5, wherein the attenuation law is an intrinsic attenuation law and the attenuation model is an intrinsic attenuation model.

8. Method according to claim 1, wherein the corrected changes in the attribute are produced by:
producing a plurality of modeled changes in the attribute between the respective pairs of depth levels using the information, and
correcting the estimated changes in the attribute with the modeled changes in the attribute.

9. Method according to claim 8, wherein the corrected changes in the attribute are produced by estimating and applying a correction factor from the modeled changes in the attribute to each of the estimated changes in the attribute.

10. Method according to claim 9, wherein the correction factor is applied to the amplitude and/or phase spectra of each of the estimated changes in attribute to produce corrected change in attribute amplitude and/or phase spectra.

11. Method according to claim 9, wherein the correction factor is a stabilized correction factor.

12. Method according to claim 10, comprising:
comparing the corrected changes in attribute amplitude and/or phase spectra with expectations from the Kramers-Kronig relations.

13. Method according to claim 8, wherein
outputting the attenuation model comprises outputting the attenuation model with uncertainties estimated from the model fit for amplitude and/or phase spectra.

14. Method according to claim 9, further comprising, when the VSP data has been gathered by receivers placed at the depth levels, correcting for receiver coupling by:
separating the upgoing and downgoing wavefields of the wavefield,
estimating a change due to receiver coupling in an attribute sensitive to receiver coupling of the downgoing and upgoing wavefields respectively,
calculating and applying modified correction factors for upgoing and downgoing wavefields, and
estimating the attenuation model based on using modified correction factors to correct estimated changes due to receiver coupling in the attribute sensitive to receiver coupling.

15. Method according to claim 1, comprising:
applying VSP pre-processing, including a broad bandpass filter, appropriate deconvolution of signatures, trace editing, and stacking for each depth level;
choosing time windows to include first arrivals;
processing VSP with standard processing for velocity and time-depth relation estimation;
calibrating sonic and density well logs; and
editing and infilling well logs to build a detailed elastic model from the start of the first time window to the end of the last time window prior to building said estimate of the transfer functions.

16. Method according to claim 15, comprising:
removal of multiples and ghosts from said VSP during pre-processing, wherein said removal comprises deconvolution.

17. Method according to claim 1, comprising:
estimating the transfer functions by match filtering.

18. Method according to claim 1, wherein the change in an attribute of the wavefield sensitive to attenuation is a transfer function, a change in instantaneous frequency, a change in rise time, a change in peak amplitude, a spectral ratio, a change in centroid frequency, a time-domain attribute, a frequency-domain attribute, or a time-frequency-domain attribute.

19. Method of obtaining an attenuation model estimate for a vertical seismic profile (VSP), comprising:
receiving a vertical seismic profile dataset;
building an estimate of the transfer function between levels based on the VSP dataset;
inputting information for modeling local interference and correcting the estimated transfer function;
choosing and fitting an effective attenuation law to the corrected transfer functions;
outputting an effective attenuation model;
characterized in that
said input information comprises measured well log and/or borehole information to model interference from interfaces near the receiver levels and choosing and fitting an attenuation law to transfer functions corrected for this interference.

20. A data processing apparatus configured to perform the method of any preceding claim 1.

21. A computer program product comprising instructions that when executed on a data processing apparatus will configure the data processing apparatus to perform the method of claim 1.
